(19) United States
(12) Patent Application Publication
(10) Pub. No.: US 2018/0152065 A1
(43) Pub. Date: May 31, 2018

(54) ROTORS FOR HIGH-SPEED BRUSHLESS MOTORS

(71) Applicant: XIAOFENG WU, DONGYANG (CN)

(72) Inventor: XIAOFENG WU, DONGYANG (CN)

(73) Assignee: ZHEJIANG LINIX MOTOR CO., LTD.

(21) Appl. No.: 15/825,886

(22) Filed: Nov. 29, 2017

(30) Foreign Application Priority Data
Nov. 30, 2016 (CN) 201611077391.2

(51) Int. Cl. H02K 1/27

(52) U.S. Cl. CPC H02K 1/2746; H02K 1/02

(57) ABSTRACT

An object of the present invention is to provide a rotor for a high-speed brushless motor, by which both the output and the power density of the motor can be greatly increased. The rotor comprises a rotor core and a plurality of magnetic poles arranged pairwise; each of the magnetic poles is provided with at least two pieces of magnetic steel of the same polarity which are distributed in a circumferential direction of an edge of the rotor, and the number of pieces of magnetic steel for each magnetic pole is the same; and each piece of magnetic steel is shaped like an arc and has the same size and structure. When there are several pieces of magnetic steel for each magnetic pole, although the pieces of magnetic steel are magnetized in parallel, the effect of radial magnetization can be achieved. Both the peaks and valleys of the air gap waveform of the motor are m-shaped, and the crests and crests of the back-EMF waveform are shaped like trapezoids. In the present invention, by forming each magnetic pole by a plurality of pieces of magnetic steel of the same polarity, the air gap clearance of the motor is reduced and the back-EMF waveform is shaped like trapezoidal wave so that the magnetic flux leakage is reduced. Thus, both the output and the power density of the motor are greatly increased.

### TECHNICAL FIELD OF THE INVENTION

The present invention relates to a brushless motor and in particular to a rotor for a brushless motor.

### BACKGROUND OF THE INVENTION

In a conventional brushless motor, especially in a two-pole motor or a four-pole motor, each magnetic pole of the rotor is provided with only one piece of magnetic steel, resulting in a large air gap clearance, a long air gap magnetic field linkage, heavy magnetic flux leakage, and a low magnetic field linkage force. Consequently, the rotor and the stator are low in kinetic energy or electric energy transfer efficiency. In other words, both the output and the power density of the motor are low.

### SUMMARY OF THE INVENTION

An object of the present invention is to provide a rotor for a high-speed brushless motor, by which both the output and the power density of the motor can be greatly increased.

For this purpose, the present invention employs the following technical solutions. A rotor for a high-speed brushless motor is provided, comprising a rotor core and a plurality of magnetic poles arranged pairwise or in pairs; each of the magnetic poles is provided with at least two pieces of magnetic steel of the same polarity which are distributed in a circumferential direction along an edge of the rotor, and the number of pieces of magnetic steel for each magnetic pole is the same; and each piece of magnetic steel is in an arc shape and has the same size and structure.

Since the pieces of magnetic steel are magnetized in parallel, when there is only one piece of magnetic steel for each magnetic pole, both the air gap waveform and the back-EMF (Electromagnetic Field) waveform of the motor are sinusoidal; and when there are several pieces of magnetic steel for each magnetic pole, although the pieces of magnetic steel are magnetized in parallel, the effect of radial magnetization can be achieved. Both the peaks and valleys of the air gap waveform of the motor are m-shaped, and the peaks and valleys of the back-EMF waveform are shaped like trapezoids. The wavelength is longer and the magnetic flux is higher. In the present invention, by forming each magnetic pole by a plurality of pieces of magnetic steel of the same polarity, the air gap clearance of the motor is reduced and the back-EMF waveform is shaped like trapezoidal wave so that the magnetic flux leakage is reduced and the magnetic flux is higher. Thus, both the output and the power density of the motor are greatly increased.

Preferably, adjacent pieces of magnetic steel are spliced together to form a ring structure.

Preferably, all the pieces of magnetic steel are annularly arranged at regular intervals around an axis of a rotor shaft. As desired, the pieces of magnetic steel in the present invention are connected to form a ring, or the adjacent pieces of magnetic steel are arranged at intervals.

Preferably, adjacent end faces of adjacent pieces of the magnetic steel come into contact with each other, and abutted surfaces of adjacent pieces of magnetic steel are overlapped with a radius line of a rotor lamination of the rotor. This arrangement ensures the uniform arrangement of the pieces of magnetic steel in the present invention.

Preferably, there are two pieces of magnetic steel for each magnetic pole.

In the present invention, each magnetic pole is provided with at least two pieces of magnetic steel so that the magnetization is equivalent to radial magnetization to achieve the effect of radial magnetization, and the air gap waveform and the back-EMF waveform changes correspondingly. Both the peaks and valleys of the air gap waveform of the motor are m-shaped (similar to two contiguous trapezoids), and the peaks and valleys of the back-EMF waveform are shaped like trapezoids (similar to two trapezoids and a V-shaped waveform between the two trapezoids or three contiguous trapezoids). The wavelength is longer and the magnetic flux is higher. In the present invention, by forming each magnetic pole by a plurality of pieces of magnetic steel of the same polarity, the air gap clearance of the motor is reduced and the back-EMF waveform is shaped as trapezoidal wave so that the magnetic flux leakage is reduced. Thus, both the output and the power density of the motor are greatly increased.

### BRIEF DESCRIPTION OF THE DRAWINGS

FIG. 1 is a structure diagram of pieces of magnetic steel according to the present invention;

FIG. 2 is a schematic view of a way of magnetizing the pieces of magnetic steel according to the present invention;

FIG. 3 is a schematic view of an air gap waveform of the motor according to the present invention; and

FIG. 4 is a schematic view of a back-EMF waveform of the motor according to the present invention.

### DETAILED DESCRIPTION OF THE PRESENT INVENTION

The present invention will be further described below by specific embodiments with reference to the accompanying drawings.

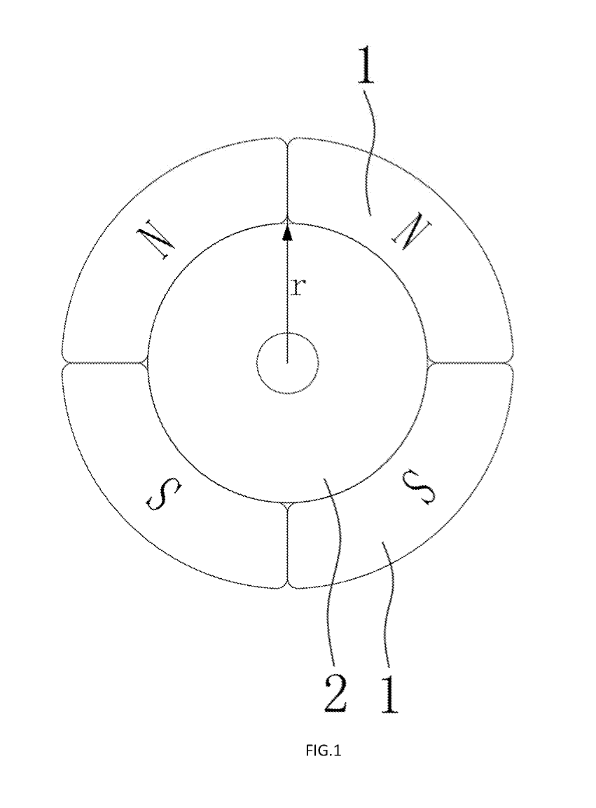

As shown in FIG. 1, a rotor for a two-pole high-speed brushless motor in the present invention comprises a rotor core and a pair of magnetic poles. Each of the S pole and the N pole is provided with two pieces of magnetic steel 1 of the same polarity. The rotor core consists of a plurality of rotor laminations 2 which are stacked above one another. The four pieces of magnetic steel 1 have the same shape, structure and size. Furthermore, the four pieces of magnetic steel 1 are distributed in a circumferential direction along an edge of the rotor. Each piece of magnetic steel 1 is in an arc shape. The pieces of magnetic steel 1 of the two magnetic poles are spliced together to form a ring structure. Adjacent end faces of adjacent pieces of the magnetic steel 1 come into contact with each other, and abutted surfaces of adjacent pieces of magnetic steel 1 are overlapped with a radius line of a rotor lamination 2.

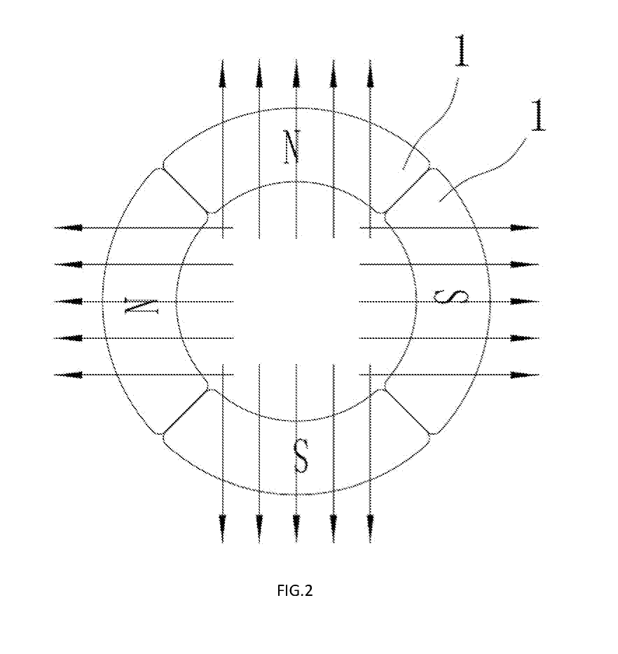

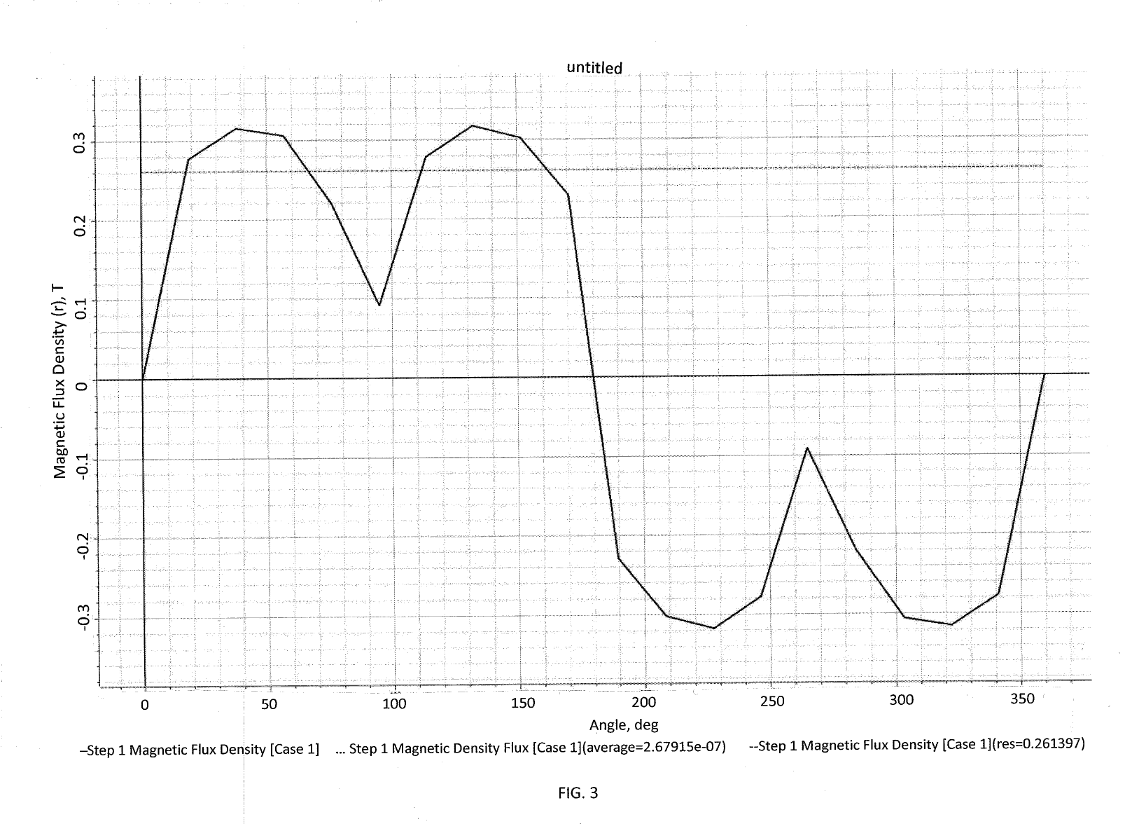

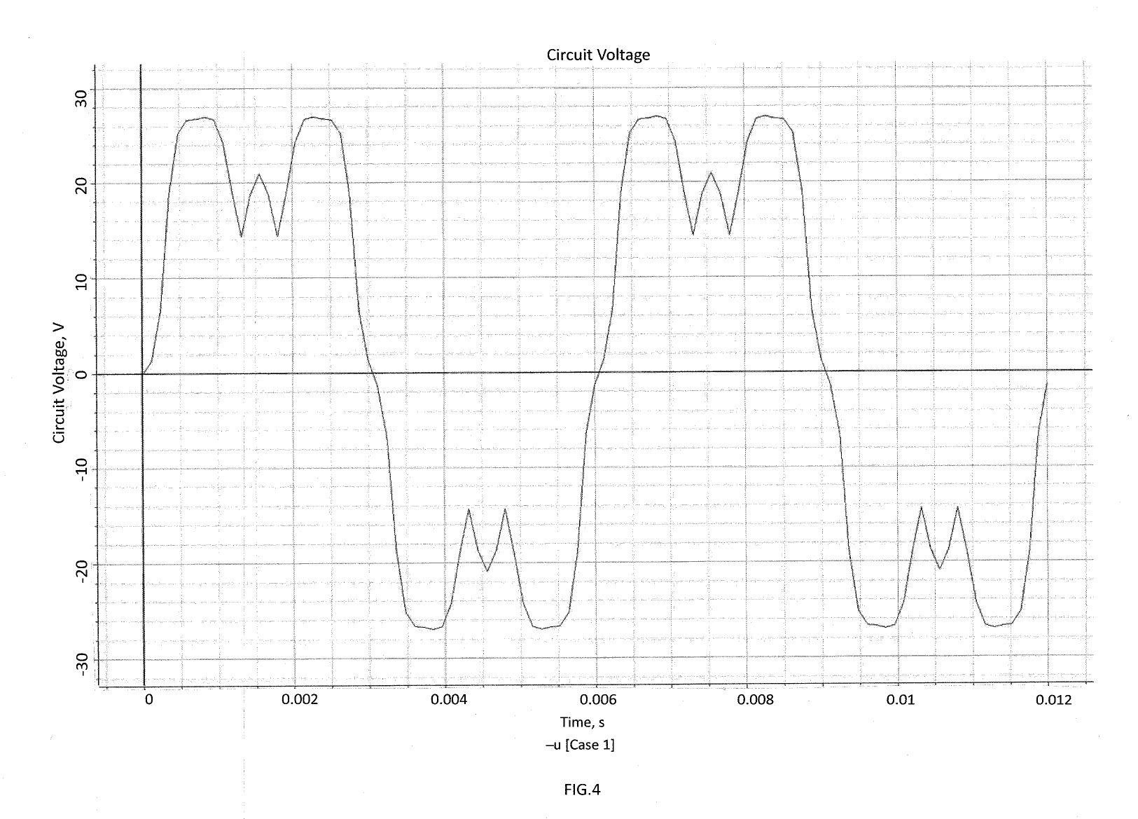

As shown in FIG. 2, the pieces of magnetic steel are magnetized in parallel. Since there are two or more pieces of magnetic steel for each magnetic pole, the magnetization is equivalent to radial magnetization to achieve the effect of radial magnetization, and the air gap waveform and the back-EMF waveform changes correspondingly. As shown in FIG. 3 and FIG. 4, both the peaks and valleys of the air gap waveform of the motor in the present invention are m-shaped (similar to two contiguous trapezoids), and the peaks and valleys of the back-EMF waveform are shaped like trapezoids (similar to two trapezoids and a V-shaped waveform between the two trapezoids or three contiguous trapezoids). The wavelength is longer and the magnetic flux is higher. In the present invention, by forming each magnetic pole by a plurality of pieces of magnetic steel of the same polarity, the air gap clearance of the motor is reduced and the back-EMF waveform is shaped like trapezoidal wave so that the magnetic flux leakage is reduced. Thus, both the output and the power density of the motor are greatly increased.

1. A rotor for a high-speed brushless motor, comprising a rotor core and a plurality of magnetic poles arranged pairwise; each of the magnetic poles is provided with at least two pieces of magnetic steel of the same polarity which are distributed in a circumferential direction along an edge of the rotor, and the number of pieces of magnetic steel for each magnetic pole is the same; and each piece of magnetic steel is in an arc shape and has the same size and structure.

2. The rotor for a high-speed brushless motor according to claim 1, characterized in that adjacent pieces of the magnetic steel are spliced together to form a ring structure.

3. The rotor for a high-speed brushless motor according to claim 1, characterized in that all the pieces of the magnetic steel are annularly arranged at regular intervals around an axis of a rotor shaft.

4. The rotor for a high-speed brushless motor according to claim 2, characterized in that adjacent end faces of adjacent pieces of the magnetic steel come into contact with each other, and abutted surfaces of adjacent pieces of the magnetic steel are overlapped with a radius line of a rotor lamination of the rotor.

5. The rotor for a high-speed brushless motor according to claim 1, characterized in that there are two pieces of the magnetic steel for each magnetic pole.
